(19) United States
(12) Patent Application Publication
(10) Pub. No.: US 2022/0176687 A1
(43) Pub. Date: Jun. 9, 2022

(54) Autonomous Application of Screen Protector

(71) Applicant: ZAGG INC, Midvale, UT (US)

(72) Inventors: Matthew DiPrimio, Midvale, UT (US); Patrick Keenan, Midvale, UT (US); Bryce Craig, Midavle, UT (US); Victor J. Eggenberger, North Versailles, PA (US); Jeffrey Beckstead, Velencia, PA (US); Manuel Carreon, Lehi, UT (US); Kirk A. Young, Pittsburgh, PA (US)

(21) Appl. No.: 17/544,495

(22) Filed: Dec. 7, 2021

Related U.S. Application Data
(60) Provisional application No. 63/123,055, filed on Dec. 9, 2020.
(60) Provisional application No. 63/132,723, filed on Dec. 31, 2020.

(51) Int. Cl. B32B 41/00; B32B 37/00; B32B 37/12; B32B 38/16

(52) U.S. Cl. CPC B32B 41/00; B32B 37/0046; B32B 2457/208; B32B 38/162; B32B 37/1207

(57) ABSTRACT

An autonomous application machine installs screen protectors on mobile devices, such as cell phones. The machine has an enclosure with an interior. A cleaning station has a cleaning implement to contact a screen of the mobile device. A magazine carries a plurality of screen protectors. A lamination station has an applicator to place a screen protector from the magazine on the screen of the mobile device. A vision inspection station has a light source and a camera to initially visually inspect the screen of mobile device prior to cleaning in the cleaning station and to verify that the screen is undamaged and free of an existing screen protector; and subsequently visually inspect the screen protector on the mobile device after installation in the lamination station and to verify that the screen protector has been properly installed.

### PRIORITY CLAIM(S) AND RELATED APPLICATION(S)

Priority is claimed to U.S. Provisional Patent Application Ser. No. 63/123,055, filed Dec. 9, 2020; and U.S. Provisional Patent Application Ser. No. 63/132,723, filed Dec. 31, 2020; which are hereby incorporated herein by reference.

### BACKGROUND

Personal electronic devices, such as cellular phones and tablets, are considered expensive and are prone to being dropped and damaged due to their portable, hand-held nature. Typical damage includes cracked or shattered screens or backs. Thus, screen protectors have been developed to be applied over the screen and/or back for protection and to reduce damage. Such screen protectors can be self-applied individually by the end user or can be applied by trained service providers. For individual self-application, the process can be daunting and prone to failure, such as misalignment, bubbles, inclusions, etc. The installation process for trained installers can be better due to greater experience and training but can still be prone to failure. The development of screen protection and installation solutions is an ongoing endeavor.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a perspective view of an autonomous application machine in accordance with an embodiment of the invention, showing an enclosure.

FIG. 2 is a partial front view of the machine of FIG. 1, showing a receptacle for initially receiving and subsequently dispensing a mobile device, an interface comprising a touch screen, and a point-of-sale (POS) for receiving and processing payment.

FIG. 3 is a front view of the machine of FIG. 1.

FIG. 4 is a perspective view of the autonomous application machine of FIG. 1, showing an installation mechanism without the enclosure.

FIG. 5 is a top view of the autonomous application machine of FIG. 1, showing the installation mechanism without the enclosure.

FIG. 6 is a rear view of the autonomous application machine of FIG. 1, showing the installation mechanism without the enclosure.

FIG. 7 is a front view of the autonomous application machine of FIG. 1, showing the installation mechanism without the enclosure.

FIG. 8 is a side end view of the autonomous application machine of FIG. 1, showing the installation mechanism without the enclosure.

FIG. 9 is a perspective view of the receptacle and a receiving station of the autonomous application machine of FIG. 1.

FIG. 10 is another perspective view of the receptacle and the receiving station of the autonomous application machine of FIG. 1.

FIG. 11 is a perspective view of a first pick-and-place mechanism of the autonomous application machine of FIG. 1.

FIG. 12 is a perspective view of a chuck of the autonomous application machine of FIG. 1.

FIG. 13 is a perspective view of the chuck of the autonomous application machine of FIG. 1, shown carrying and securing a mobile device.

FIG. 14 is a top view of the chuck of the autonomous application machine of FIG. 1.

FIG. 15 is a top view of the chuck of the autonomous application machine of FIG. 1, shown carrying and securing the mobile device.

FIG. 16 is a perspective view of a vision system and a vision inspection station of the autonomous application machine of FIG. 1.

FIG. 17 is an end view of the vision system and the vision inspection station of the autonomous application machine of FIG. 1.

FIG. 18 is a top view of the vision system and the vision inspection station of the autonomous application machine of FIG. 1.

FIG. 19 is a top perspective view of a cleaning implement and a cleaning station of the autonomous application machine of FIG. 1.

FIG. 20 is a bottom perspective view of the cleaning implement and the cleaning station of the autonomous application machine of FIG. 1.

FIG. 21 is a top perspective view of a delamination bed and a delamination station of the autonomous application machine of FIG. 1.

FIG. 22 is a top perspective view of the delamination bed and the delamination station of the autonomous application machine of FIG. 1, shown with a screen protector thereon.

FIG. 23 is a top view of the delamination bed and the delamination station of the autonomous application machine of FIG. 1.

FIG. 24 is a top perspective view of a second pick-and-place mechanism of the autonomous application machine of FIG. 1.

FIG. 25 is a side view of the second pick-and-place mechanism of the autonomous application machine of FIG. 1.

FIG. 26 is a bottom perspective view of the second pick-and-place mechanism of the autonomous application machine of FIG. 1.

FIG. 27 is a bottom perspective view of the second pick-and-place mechanism of the autonomous application machine of FIG. 1, shown carrying a screen protector.

FIG. 28 is a bottom view of the second pick-and-place mechanism of the autonomous application machine of FIG. 1.

FIG. 29 is a bottom view of the second pick-and-place mechanism of the autonomous application machine of FIG. 1, shown carrying a screen protector.

FIG. 30 is a perspective view of a vacuum chamber and a vacuum sealing station of the autonomous application machine of FIG. 1.

Reference will now be made to the exemplary embodiments illustrated, and specific language will be used herein to describe the same. It will nevertheless be understood that no limitation of the scope of the invention is thereby intended.

### DETAILED DESCRIPTION

Before invention embodiments are disclosed and described, it is to be understood that no limitation to the particular structures, process steps, or materials disclosed herein is intended, but also includes equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence. Unless defined otherwise, all technical and scientific terms used herein have the same meaning as commonly understood by one of ordinary skill in the art to which this disclosure belongs.

The terms “mobile device”, “personal electronic device”, “electronic device”, and “cell phone” are used interchangeably herein, unless otherwise specified, to refer to a portable handheld electronic device, such as a cellular or cell phone, smartphone, tablet or tablet computer, phablet, wearable, game, and the like, with a display screen, and that is portable and handheld. The display screen can be a touch screen that can receive input by touch such as finger swipes, and/or can have a virtual keyboard. The mobile device can have a battery and memory and a processor with software running thereon. The mobile device can have cellular, WiFi and/or Bluetooth connectivity, and can have a wireless transmitter, receiver, or transceiver. Thus, the mobile device can provide internet browsing, game playing, movie and picture display, e-book display, etc. In addition, the mobile device can include a digital camera. Throughout the description, the term “cell phone” will be used as an example of the mobile device, and such use of the term “cell phone” includes all mobile devices or portable handheld electronic devices, unless otherwise specified. Similarly, throughout the drawings a cell phone is shown by way of example.

The term “screen protector” refers to a material such as glass, film, a hybrid of glass and film that adheres to a screen of a mobile device, or a fluid that is applied to the screen and subsequently cures or solidifies. The term “screen protector” can refer to a layer or film placed on or over a display screen of the mobile device to provide protection to the display screen. The screen protector can comprise one or more layers, such as a protective glass or plastic layer, an adhesive layer to affix the protective layer to the screen of the mobile device, etc. The screen protector can be transparent such that the display screen can be viewed through the screen protector. In one aspect, the screen protector can be flexible and can comprise a flexible film supported by the screen of the mobile device. In another aspect, the screen protector can be rigid enough to maintain its shape and be self-supporting. In one aspect, the screen protector can be disposed directly on the display screen. In another aspect, the screen protector can be disposed over and above the display screen, with a space or gap therebetween. The screen protector can have a size and shape to substantially match or cover the display screen. In addition, the screen protector can extend beyond the display screen and cover other portions of a user surface of the portable handheld electronic device. The screen protector can have notches or cut-outs in the perimeter thereof, and/or apertures therethrough, to accommodate accessories of the portable handheld electronic device, such as a camera lens, a speaker, a button, fingerprint sensor, etc. In addition, the screen protector can have lateral sides that are curved to match or follow a curvature of the display screen, which can have curved lateral sides extending to lateral edges of the portable handheld electronic device. The outermost lateral edges of the screen protector can contact the display screen to eliminate a gap at the lateral perimeter of the screen protector and the display screen. Thus, the curvature of the lateral edges of the screen protector can have a slightly different curvature than the lateral edges of the display screen. The term “screen protector” is also used to refer to similar protective layers that can be installed on the back of the device to protect the glass thereof. By way of example, the screen protectors described and shown herein can be tempered glass with an adhesive thereon to adhere the screen protector to the screen of the mobile device. In addition, the screen protectors can be provided with a protective film covering the adhesive prior to installation.

An initial overview of the inventive concepts are provided below and then specific examples are described in further detail later. This initial summary is intended to aid readers in understanding the examples more quickly, but is not intended to identify key features or essential features of the examples, nor is it intended to limit the scope of the claimed subject matter.

An autonomous application machine and method are provided for automatically applying and installing a screen protector, such as an adhesive glass, to a display screen of a mobile device, such as a cell phone. The machine can receive the mobile device, verify the mobile device, prepare and clean the mobile device, select or produce a screen protector, delaminate a protective film from the adhesive of the screen protector, orient and position the mobile device and/or the screen protector with respect to one another, apply the screen protector to the mobile device, seal and/or press/roll the screen protector and mobile device to remove air bubbles, and/or verify the installation. The machine can comprise one or more stations, such as a receiving station, a visual inspection station, a cleaning station, a delamination station, a lamination station, and/or a vacuum seal station. The mobile device and the one or more stations can move with respect to one another. In one aspect, the mobile device can be moved through the one or more stations, such as carrying the mobile device on a carriage movable on a rail, or on a carrousel. In another aspect, the one or more stations can be moved past a stationary mobile device, such as with a carrousel.

The application machine is autonomous in that the machine can operate autonomously, without supervision or manual assistance. Thus, the machine can provide precise installation without the need of a trained operator; and can even provide installation for a consumer, without an operator. In one aspect, the machine can be used by an unskilled or limited skilled workforce, such as in a retail establishment. In another aspect, the machine can be used by a consumer as a point-of-sale (POS) apparatus or kiosk.

The machine can be a vending and application machine for both vending and applying the screen protector. The machine can have an installation mechanism housed within an enclosure or shell to both protect the mechanism from interference and to protect consumers/operators from the mechanism. A user interface can be carried and located proximate an exterior of the enclosure. The user interface can comprise a display screen and input, such as a touchscreen, to: 1) present one or more different screen protector for one or more different mobile devices, and an installation service for installing a selected screen protector on a mobile device, for sale, and 2) receive a selection. The user interface can also comprise a payment processor, such as a card scanner and/or NFC, to processes a payment for the screen protector and the installation service. The user interface and the display can provide a GUI that provides the ability for the machine to interact directly with the consumer, without a trained operator.

The machine can utilize a vision system for visually scanning and inspecting: 1) the screen of the mobile device prior to installation of the screen protector, and 2) the screen protector subsequent to installation. The vision system can provide a visual verification system that allows the machine to verify the condition of the screen and the mobile device both before and after installation. Thus, the machine can protect against unfounded claims of damage to the mobile device or improper installation of the screen protector. The vision system can comprise an array of light sources directed at the screen of the mobile device from an array of different angles. The vision system can further comprise an array of cameras directed at the screen of the mobile device from an array of different angles. The cameras can utilize sensors, such as CMOS, to detect diffraction of light from any cracks in the screen of the mobile device, and/or debris on the screen. In another aspect, the machine can also have a vision system to visually inspect a back of the mobile device, which can typically comprise glass.

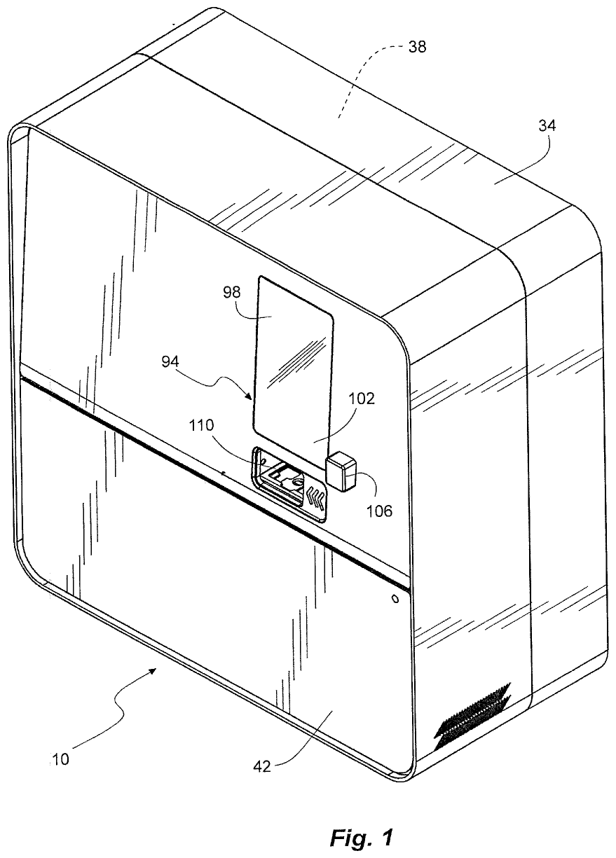

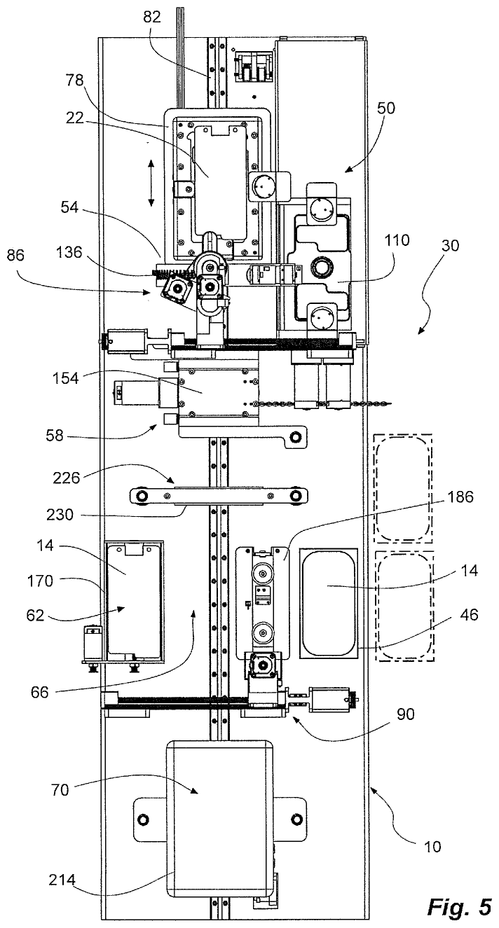

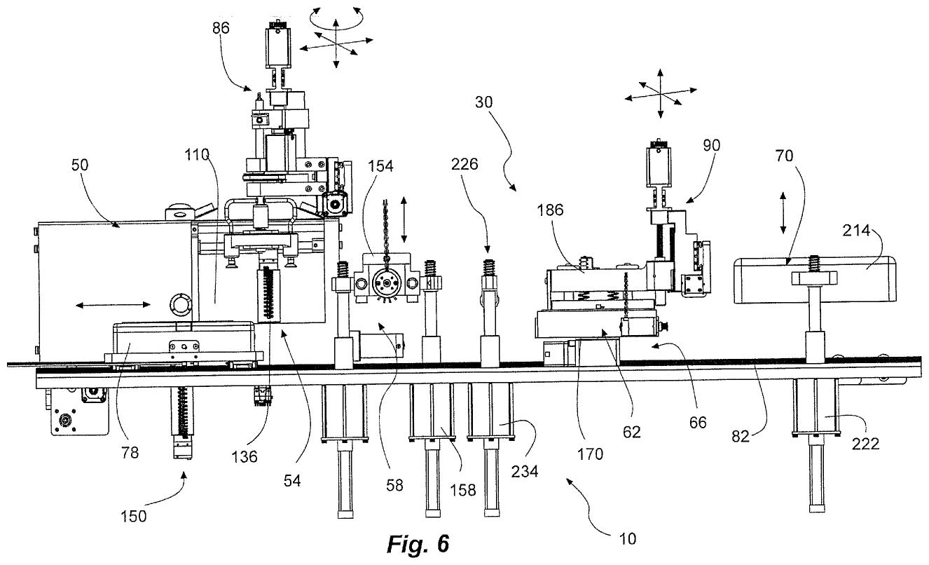

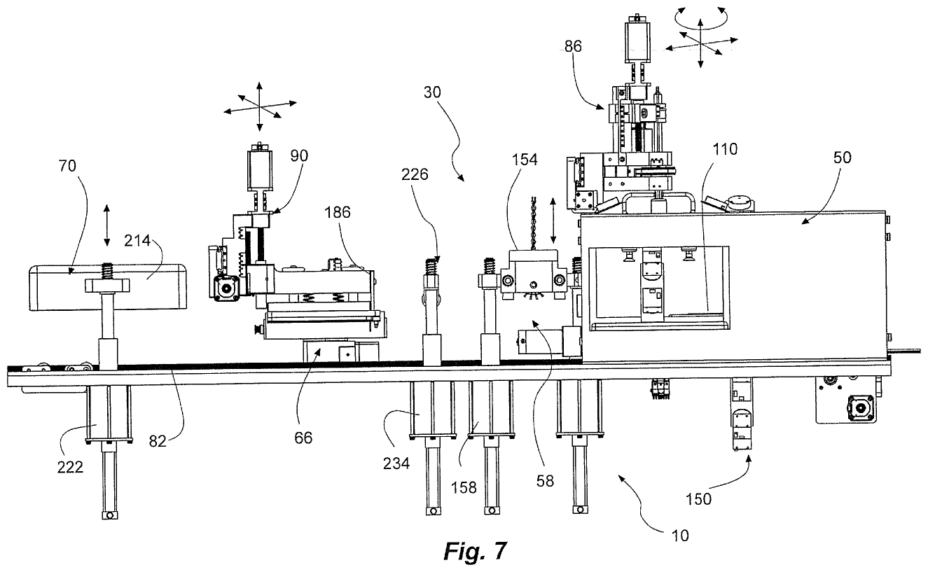

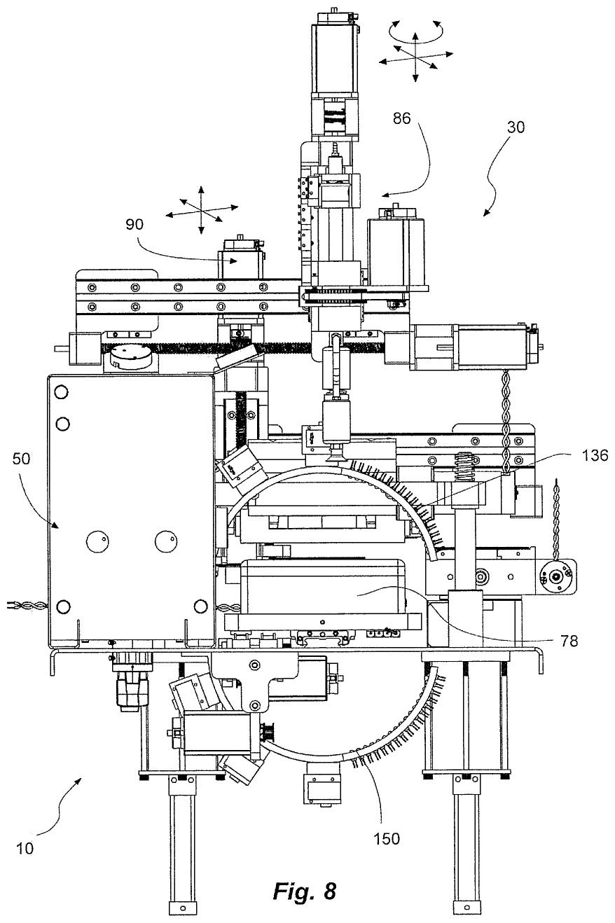

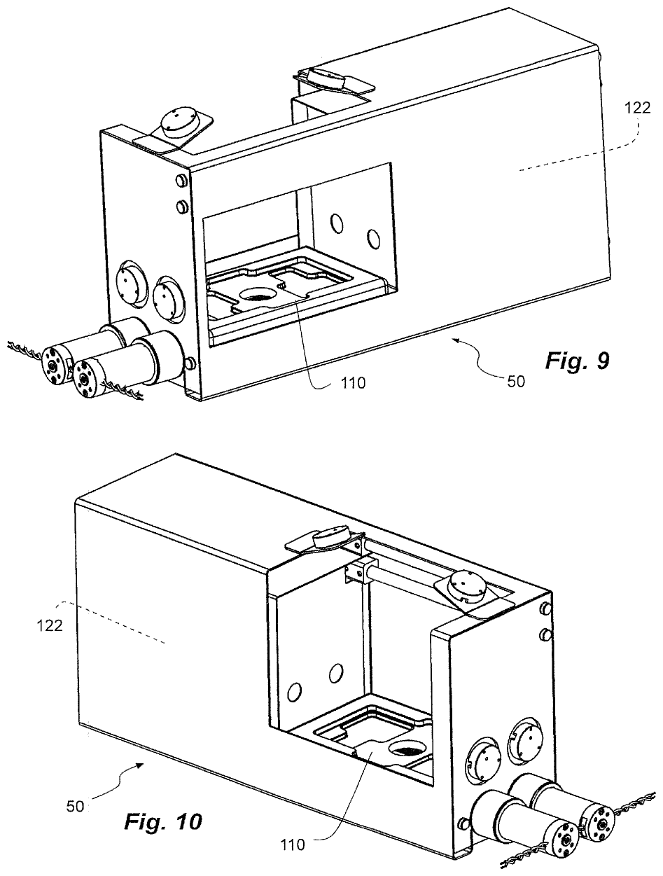

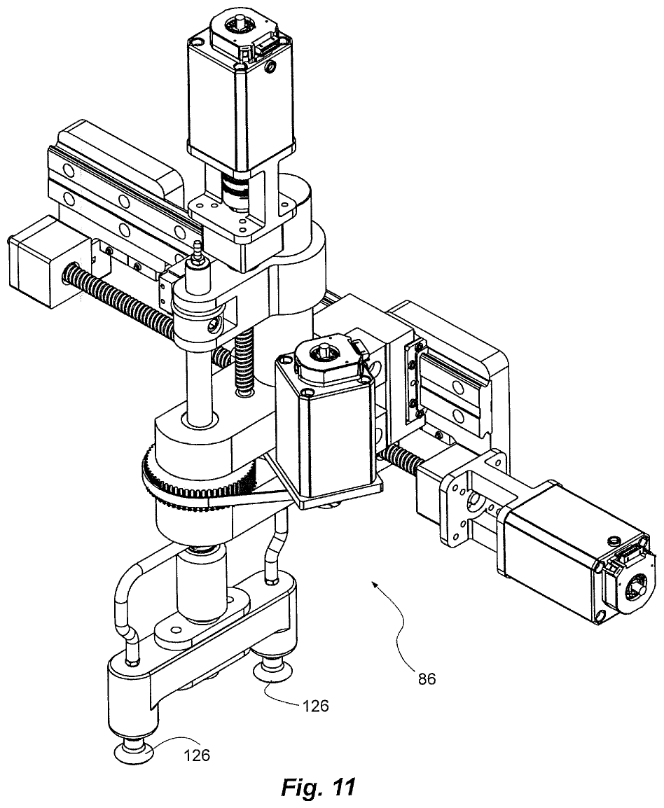

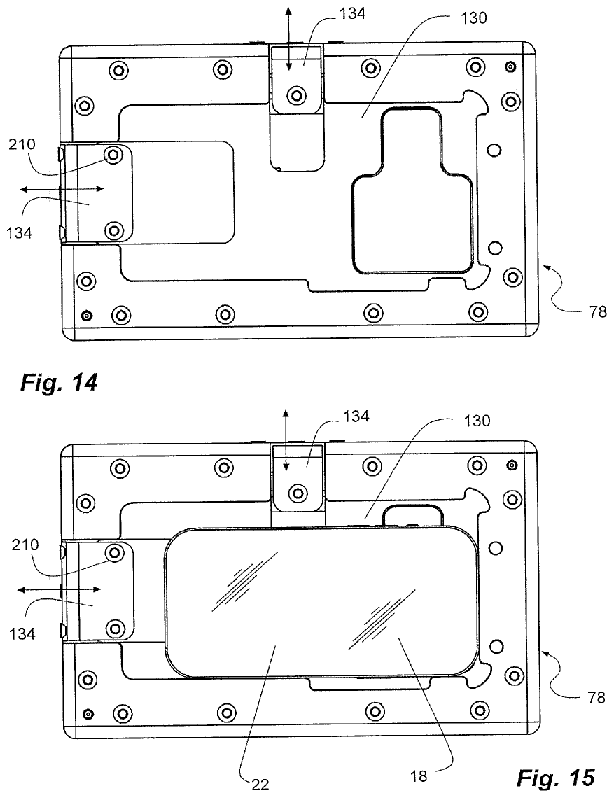

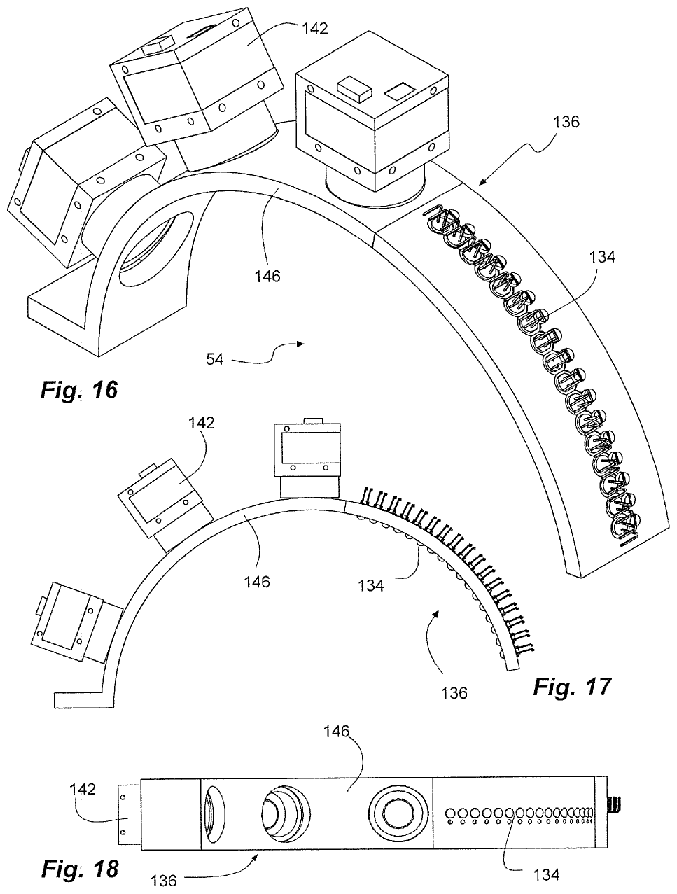

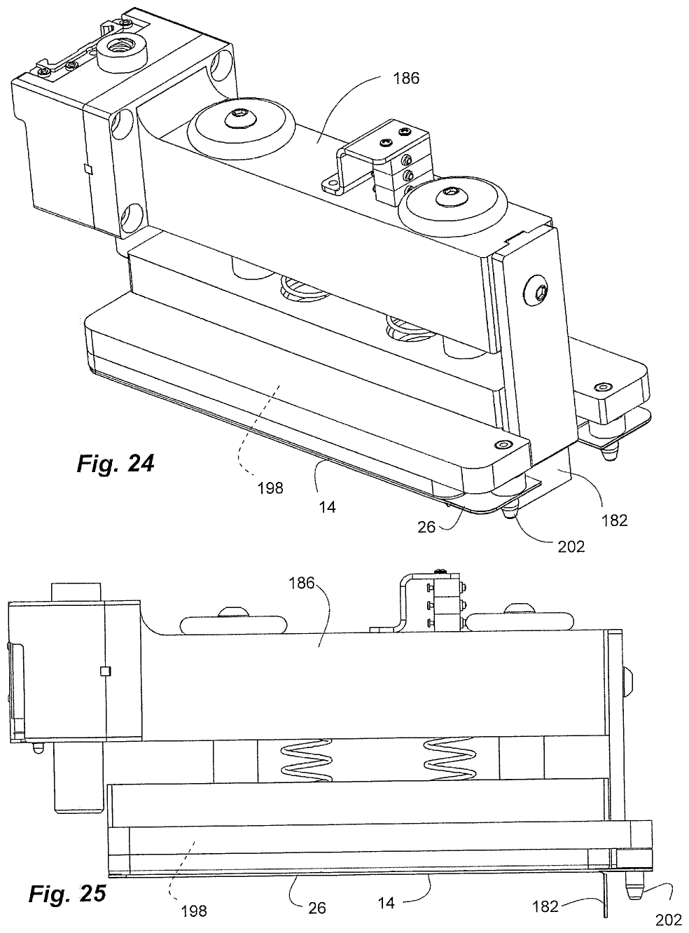

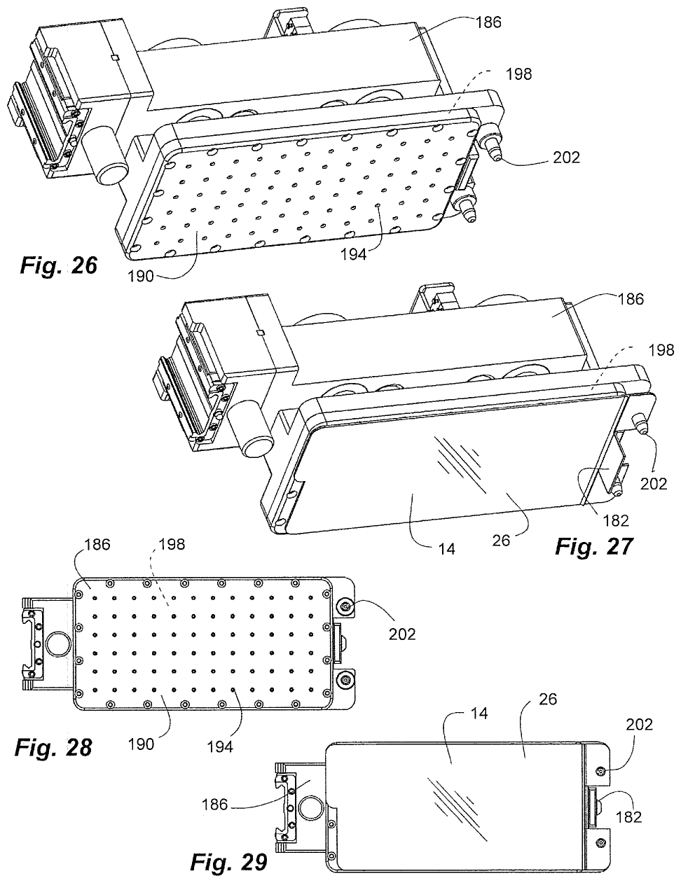

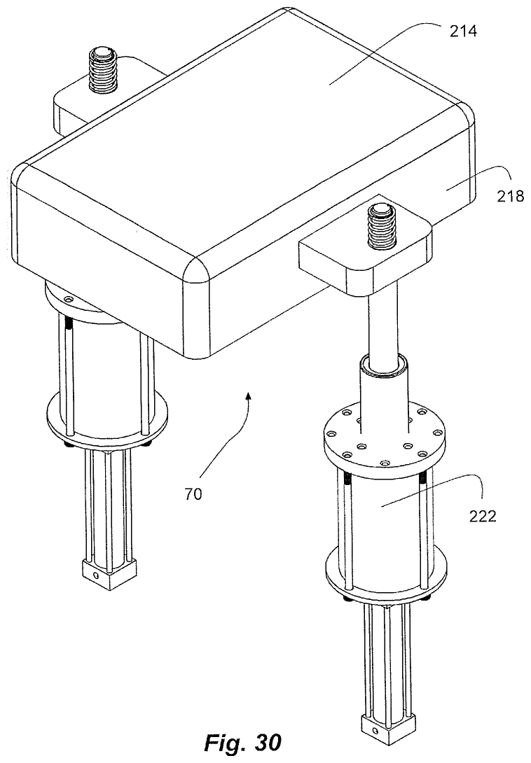

Referring to FIGS. 1-30, an autonomous application machine 10 is shown by way of example for applying and installing a screen protector(s) 14 (FIGS. 22, 27 and 29) on a screen 18 (or back) of a mobile device(s) 22 (FIGS. 13 and 15). As described above, the mobile device 22 can be a cellular or smart phone, while the screen protector 14 can comprise a tempered glass with an adhesive covered by a protective film 26 (FIG. 22). In another aspect, the screen protector 14 can have a second protective film opposite the first protective film 26 so that the screen protector 14 is sandwiched between the two protective films.

The machine 10 can comprise an application mechanism 30 housed within an enclosure 34 in the interior 38 thereof. In one aspect, the enclosure 34 can define a volume of the interior 38 and can completely enclose the volume. Thus, the enclosure 34 can resist outside interference with the mechanism 30, and can protect users, such as operators or consumers, from the mechanism 30. In another aspect, the enclosure 34 can have walls that are solid to resist entry of airborne particulates. In another aspect, the machine 10 and the enclosure 34 can have a window to allow observation of the installation of the screen protector 14. Since the machine 10 and the mechanism 30 are completely autonomous, access to the interior 38 by the operator or consumer is unnecessary. The enclosure 34 can have an access panel or door 42 to allow maintenance of the mechanism 30, to restock screen protectors 14, and to collect debris, such as protective films 26. In one aspect, the enclosure 34 can be floor standing. In another aspect, the enclosure 34 can be a desktop or tabletop unit. At least one magazine 46 can be located in the enclosure 34 to contain a stack of screen protectors 14. Multiple difference screen protectors 14 sized and shaped for different mobile devices 22 can be carried in multiple magazines 46.

The machine 10 and the mechanism 30 can have multiple stations in the interior 38 of the enclosure 34 for performing different operations with respect to the mobile device 22 and/or the screen protector 14. For example, the stations can comprise:
1) A receiving station 50 for initially receiving the mobile device 22 into the enclosure 34 and the machine 10, and for subsequently presenting the mobile device 22 with the screen protector 14 thereon. The receiving station 50 can also define an interface between the exterior of the enclosure 34 and the interior 38 of the enclosure, and between a consumer/operator and the mechanism 30.
2) A vision inspection station 54 for initially visually inspecting the screen 18 (and/or back) of a mobile device 22 prior to cleaning in a cleaning station, and to verify that the screen 18 (and/or back) is undamaged and free of an existing screen protector and/or debris. The vision inspection station 54 can also subsequently visually inspect the screen 18 (and/or back) of the mobile device 22 after cleaning in the cleaning in the cleaning station. The vision inspection station 54 can also subsequently visually inspect the screen protector 14 on the screen 18 (and/or back) of the mobile device 22 after installation in a lamination station, and to verify that the screen protector 14 has been properly installed.
3) A cleaning station 58 to contact and clean the screen 18 (and/or back) of the mobile device 22.
4) A delamination station 62 to receive the screen protector 14 with the protective film 26 thereon, and to remove the protective film 26 from the screen protector 14 and expose the adhesive.
5) A lamination station 66 to laminate the screen protector 14 with the exposed adhesive to the screen 18 (and/or back) of the mobile device 22.
6) A vacuum sealing station 70 to seal the screen protector 14 to the screen 18 (and/or back) of the mobile device 22, and/or to remove any air bubbles under the screen protector 14.

In addition, the machine 10 and the mechanism 30 can have a carriage-and-rail system 74 to transport the mobile device 22 through the various stations. A chuck 78 can be positioned in the interior 38 of the enclosure 34 to carry the mobile device 22 during the installation process. The chuck 78 can be at least part of the carriage, and can ride on the rail 82 that can extend through or proximate to the stations. In one aspect, the chuck 78 can move back-and-forth along the rail 82 and between the stations. For example, the chuck 78 and the mobile device 22 can move from the receiving station 50 through the other stations to the sealing station 70, and then back to the receiving station 50. As another example, the chuck 78 and the mobile device 22 can move from the vision inspection station 54 to the cleaning station 58, and then back to the vision inspection station 54.

Furthermore, the machine 10 and the mechanism 30 can also have:
1) A first pick-and-place mechanism 86 positioned in the interior 38 of the enclosure 34 to transition and/or transport the mobile device 22 between the receiving station 50 and the chuck 78.
2) A second pick-and-place mechanism 90 positioned in the interior 38 of the enclosure 34 to transition and/or transport: i) the screen protector 22 with the protective film 26 from the magazine 46 to the delamination station 62; and ii) the screen protector 22 with the protective film 26 removed and the adhesive exposed from the delamination station 62 to the lamination station 66. The first and second pick-and-place mechanism 86 and 90 can be different.

Referring to FIGS. 1-3, the machine 10 and the enclosure 34 can have a user interface 94 carried on a front exterior of the enclosure 34 and can be forward facing. The user interface 94 can comprise a display 98 and an input 102 capable of presenting the screen protector for the mobile device and receiving a selection, respectively. In one aspect, the display 98 and the input 102 can comprise a touch screen liquid crystal display (LCD). In another aspect, the display 98 can comprise an LCD and the input 102 can comprise at least one button. In one aspect, the display 98 can display a representation of the screen protector(s) 14 and/or the corresponding mobile device 22. In another aspect, the user interface 94 and the display 98 can present the screen protector(s) 14 and the installation service for sale. The user interface 94 can further comprise a payment processor 106 for processes a payment for the screen protector 14 and/or the installation service. The payment processor 106 can comprise a credit card reader for reading a strip and/or chip of a credit card, and/or a touch interface/NFS for reading a credit card, cell phone, smart watch, etc.

The user interface 94 and the display 98 can have a GUI that can present instructions and options. For example, the GUI can present:
1) a launch screen;
2) a menu of options including mobile device brands, device scanning, bar code scanning, and/or QR code scanning;
3) a menu of brand models;
4) instructions and graphics to remove any case on the mobile device;
5) instructions to remove any preexisting screen protector;
6) instructions to preliminarily clean the screen of the mobile device;
7) instructions on how to orient and insert the mobile device with respect to the receiving station;
8) a menu of screen protector options and associated cost;
9) a checkout screen presenting the selection and final cost;
10) an option to enter a discount code or scan a QR code associated with a discount or prepaid screen protector;
11) instructions for payment and using the payment processor;
12) an option to enter personal information such as name, phone number and/or email address; and
13) a graphical representation of the mobile device and the screen protector processing.

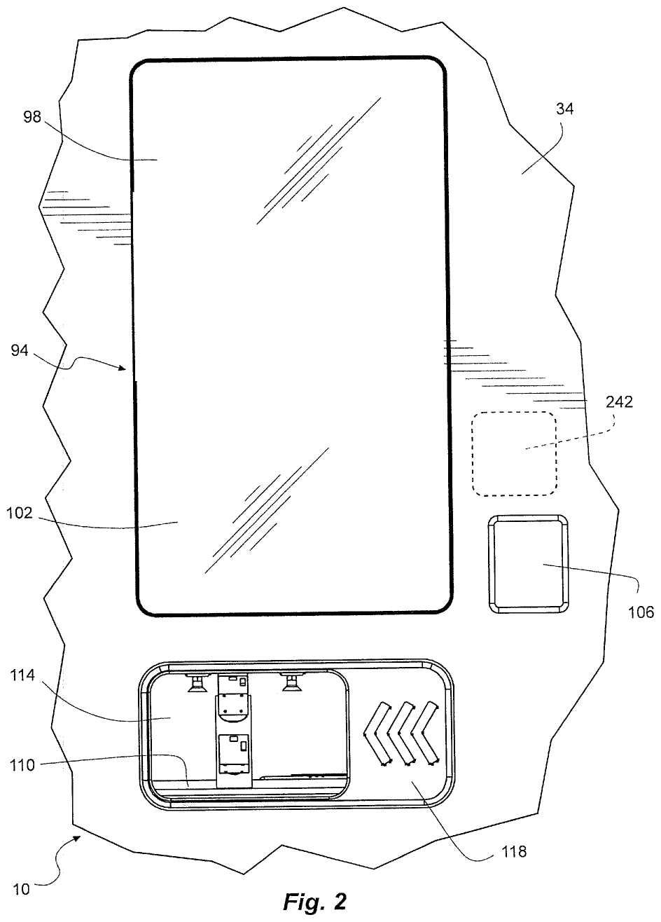

Referring to FIGS. 1-10, the receiving station 50 can comprise a receptacle 110 associated with the enclosure 34 and accessible only outside the enclosure 34. The receptacle 110 is sized and shaped to initially receive the mobile device 22 and subsequently dispense the mobile device 22 with the screen protector 14 thereon. The receiving station 50 and the receptacle 110 can have an opening 114 in the enclosure 34 that can be closed by a panel 118, as shown in FIG. 2. In one aspect, the panel 118 can be lockable to restrict access through the opening 114 to the mobile device 22 during operation. Thus, the panel 118 and the opening 114 can have a lock to resist opening. The receiving station 50 and the receptacle 110 can be separated from the chuck 78, the interior 38 of the enclosure 34, and the mechanism 30. Thus, the receiving station 50 and the receptacle 110 can defining an interface and a barrier between the operator/consumer and the mechanism 30 for safety.

In another aspect, the machine 10, the enclosure 34, the receiving station 50 and the receptacle 110 can comprise a drawer, or a slot through which a user can insert the mobile device 22 into the receiving station 50. In one aspect, the drawer can be lockable, and the slot can be closable, to restrict access during use. In addition, the slot can be sized to only receive the mobile device.

In one aspect, the receptacle 110 can comprise actuators and sensors for sensing a perimeter of the mobile device 22 for determining the brand and model of the mobile device 22. In another aspect, the receptacle 110 can comprise a scanner 122 for scanning the mobile device 22 for determining the brand and model of the mobile device 22. In another aspect, the receptacle 110 can comprise sensors for determining the orientation of the mobile device 22.

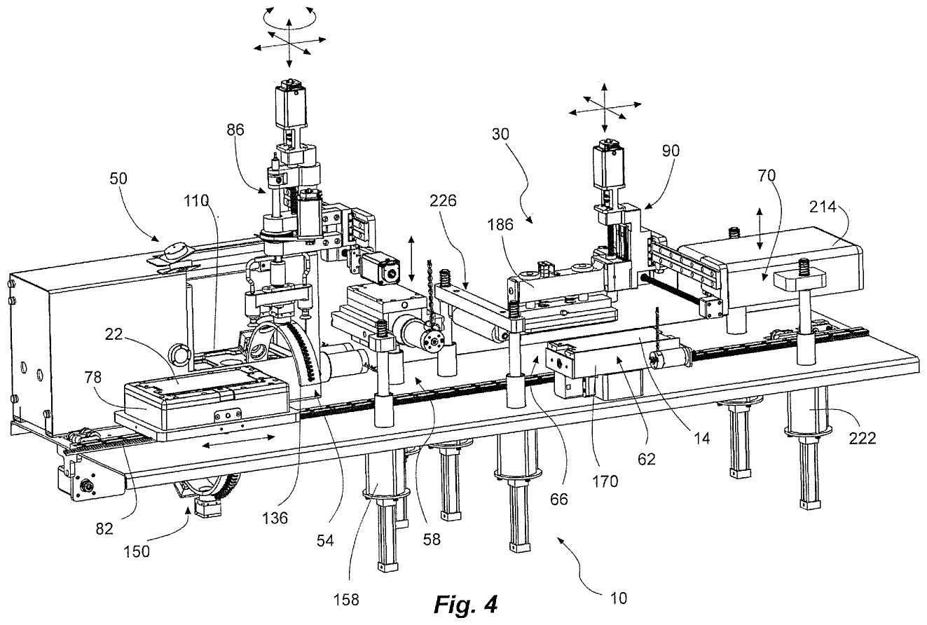

Referring to FIGS. 4-8 and 11, the first pick-and-place mechanism 86 can comprise a gripper, such as a vacuum grip 126, capable of grasping the mobile device 22. In addition, the pick-and-place mechanism 86 can comprise horizontal and vertical screw drives to raise/lower and transport the grip 126 with the mobile device 22 from the receptacle 110 to the chuck 78 in the interior 38 of the enclosure 34. Furthermore, the pick-and-place mechanism 86 can have a drive, belt and gear to rotate the grip 126 with the mobile device 22 to properly orient the mobile device 22 with respect to the chuck 78. The grip 126 can have suction cups coupled to a vacuum source in the enclosure and/or carried by the pick-and-place mechanism 86.

The pick-and-place mechanism 86 can be a three axis assembly with three linear axes of motion in a gantry configuration. The pick-and-place mechanism 86 can have lateral and longitudinal movement to cover the span to position the vacuum grip 126 in all required planar locations, and between the receptacle 110 and the chuck 78. In addition, the pick-and-place mechanism 86 can have vertical rise and fall movement to raise and lower the vacuum grip 126. The pick-and-place mechanism 86 can have force limiting, spring loaded mechanisms between the axis connection and the chuck 78 so that the vacuum grip 126 does not exert excessive force on the mobile device 22.

In one aspect, the machine 10 and the pick-and-place mechanism 86 can include a stationary touch probe with a cylindrical stylus pointed up. The probe is used to initialize the home position of the pick-and-place mechanism and to measure an offset of the edge of a mobile device 22.

Referring to FIGS. 4-8 and 12-15, the chuck 78 can have an indentation 130 to receive the mobile device 22. Two contiguous sides of the indentation 130 can be fixed, while portions of opposite contiguous sides of the indentation 130 can displace to grip the mobile device 22. For example, fingers 134 or tabs on the two contiguous side can displace towards and away from the mobile device 22 by actuators.

The chuck 78 can be a holding fixture for the mobile device 22, and can comprise a base plate mounted on a linear slide that transports the base plate and the mobile device 22 to the subsequent stations. An intermediate plate can comprise spring loaded jaws, fingers or tabs perpendicular to one another and mounts on top of the base plate. These jaws, fingers or tabs can be opened pneumatically via integrated cylinders, whereas compressed air can open the jaws and spring force can close them. This arrangement can resist the jaws, fingers or tabs will not grip the mobile device 22 with excessive force, or from failing to close. Top tooling correspond to the top jaws, fingers or tabs can be fastened to the intermediate plate and jaws, fingers or tabs, respectively. This tooling can hold the mobile device through direct contact while minimizing the number of top tooling components to just one set for all types of mobile devices.

In another aspect, the chuck 78 can have a platen with a suction device that can apply a pressure to a back of the mobile device 22 to hold the mobile device with respect to the platen. In another aspect, the chuck 78 can have a platen with one or more indentations each sized and shaped to receive a particular mobile device. In one aspect, a single blank with an indentation can be provided on the platform or platen based on the identified mobile device.

The vision inspection station 54 can comprise a vision system 136 with a light source, such as an array of lights or LEDs 138 oriented at different angles with respect to the chuck 78 and thus the screen 18 of the mobile device 22. In addition, the vision inspection station 54 and the vision system can comprise a camera, such as an array of cameras 142 also oriented at different angles with respect to the chuck 78 and thus the screen 18 of the mobile device 22. The cameras 142 and the LEDs 138 can be oriented opposite one another. In one aspect, the cameras 142 and the LEDs 138 can be oriented at an acute angle with respect to the screen 18 of the mobile device 22. The array of cameras 142 and the array of LEDS 138 provide multiple viewing angles and multiple light paths in order to thoroughly inspect the screen 18 of the mobile device 22. In another aspect, the cameras 142 and the LEDs 138 can be carried by an arch 146 with the cameras 142 on one side of the arch 146 and the LEDs 138 on the other side of the arch 146. The cameras 142 and the LEDs 138 can operate through respective apertures in the arch 146.

The array of cameras and light sources 142 and 138 can be arranged in the arch 146 where the chuck 78 and the mobile device 22 pass under. The array of cameras and light sources 142 and 138 can image the surface of the screen 18 at various oblique angles as well as normal to the screen 28. Various wavelengths can be used from visible light to near IR. In one aspect, the arch 146 can be fixed. In another aspect, the arch 146 can move with respect to the screen 18 of the mobile device 22 and the chuck 78. For example the arch 146 can move longitudinally and/or transverse to the screen 18.

In one aspect, the vision system 136 can observe the screen 18 of the mobile device 22 and the condition thereof to ensure that it is clean. In another aspect, the vision system can measure the mobile device 22 for comparison with the user's identification of the brand and the model, and verify that the proper screen protector 14 has been selected. In another aspect, the vision system can validate whether the mobile device 22 has an existing screen protector. For example, the visions system can be capable of detecting an edge or change in elevation in the screen 18 around an aperture or adjacent a perimeter that would indicate the presence of an existing screen protector. In another aspect, the vision system can validate whether the mobile device 22 has a case. In another aspect, the vision system can validate whether the screen 18 of the mobile device 22 is already cracked or damaged. For example, the visions system can be capable of detecting a change in the surface of the screen 18 that would indicate the presence of a crack. In another aspect, the vision system can observe and document the condition of the mobile device 22 and screen 18 prior to installation of the screen protector 14. In another aspect, the vision system can validate the condition of the screen protector 14 prior to installation. In another aspect, the vision system can validate and document the mobile device 22 and the screen protector 14 after installation to validate and document correct installation. In one aspect, the vision system can use the cameras 142 and the LEDs 138, and associated object identification systems. In another aspect, the vision system can use acoustic sensors, or sonic or ultrasonic sensors. In another aspect, the vision system can use infrared sensors. In another aspect, the vision system can use x-ray sensors.

In accordance with another aspect, vision inspection station 54 and the vision system 136 described above can be a front and upper vision system positioned and oriented in front of the mobile device 22 and above the chuck 78 for inspecting the front of the mobile device 22. In another aspect, the machine 10 can have a back and lower vision system 150 positioned and oriented behind and below the mobile device 22 for inspecting the back of the mobile device 22. For example, the first pick-and-place mechanism 86 can position, orient and move the mobile device 22 with respect to the back and lower vision system 150 while transporting the mobile device 22 between the receiving station 50 and the chuck 78, and prior to placing the mobile device 22 in the chuck 78. The back and lower vision system 150 can be similar to or the same as the front and upper vision system 136 described above.

Referring to FIGS. 4-8, 19 and 20, the cleaning station 58 can have a cleaning implement 154 to contact the screen 18 of the mobile device 22. The cleaning implement 154 can be positioned over the chuck 78 and the mobile device 22, and can be moved towards and away from the chuck 78 and the mobile device 22 by actuators 158. The cleaning implement 154 can comprise a rotating nylon brush 162 with bristles and/or resilient vanes to sweep over the screen 18 and to brush and/or wipe the screen 18 and displace any debris thereon. In one aspect, the cleaning implement 154 can have at least one vacuum head 166 adjacent the rotating brush 162 to carry away the debris. In another aspect, the rotating brush 162 can be positioned between a pair of spaced-apart vacuum heads 166. The vacuum head 166 can be coupled by a tube to a vacuum source with a bin to collect the debris and a filter to catch particulates to resist contaminating the interior 38 of the enclosure 34.

The cleaning station 58 can carefully and repeatably clean the screen 18 of the mobile device 22. In another aspect, the cleaning station 58 and the cleaning implement 154 can comprise a buffer, a compressed air nozzle, a sprayer for cleaner, such as isopropyl alcohol, and/or an adhesive sprayer. In another aspect, the machine 10 and the enclosure 34 can comprise containers of cleaner, such as isopropyl alcohol, coupled to the sprayer or nozzle. In another aspect, mist nozzles can spray a fine mist of alcohol onto the rotating brush 162 and/or the screen 18 while the brush is in motion. The chuck 78 with the mobile device 22 can reciprocate back and forth below the rotating brush 162 and along its linear axis. In another aspect, the vacuum head 166 can have a vacuum nozzles with nylon brushes around the perimeter to augment cleaning and/or drying of the screen 18. The chuck 78 can cycle until the screen 18 is clean and/or dry, and verified at the vision inspection station 54. The cleaning implement 154 can raise and lower on actuators so that the rotating brush 162 and/or the vacuum head 166 contacts and clears the screen 18. The actuators can comprise air cylinders coupled to a pneumatic source. A force limiting mechanism can be included, so that excessive force is not applied to the screen 18. For example, a spring transmitting force from the cylinder to a frame of the cleaning implement 154 can be used so that if transmitted force exceeds the spring force, the spring will deflect, thus limiting force. Such a lift mechanism can also be used in other stations.

Referring to FIGS. 4-8, the at least one magazine 46 can be located in the interior 38 of the enclosure 34 and adjacent and proximate to the rail 82 and the mechanism 30. In one aspect, the machine 10 and the enclosure 34 can store and stock multiple screen protectors 14. The screen protectors can be stocked and stacked in the magazine 46. In another aspect, the machine 10 and the enclosure 34 can store and stock a plurality of different screen protectors 14 that are sized and shaped for particular different mobile devices 22. The similar or the same screen protectors 14 can be provided in separate stacks and separate magazines. Thus, the at least one magazine 46 can comprise multiple magazines arranged in an array or matrix adjacent and proximate to the mechanism 30. In one aspect, the magazines 46 can be interchangeable and removed and replaced from the machine 10. Thus, the machine 10 can be serviced by opening the door 42 and interchanging empty or incomplete magazines with full magazines. Alternatively, the empty or incomplete magazines can be filled with screen protectors. The magazines 46 can have identification that can be sensed by the machine 10 to identify the type of screen protector 14 therein.

The magazine 46 can be a hollow rectangular structure with guides along its internal length. The guides can constrain the stack of screen protectors 14 so they are aligned square to the frame. In one aspect, one guide can be fixed and the opposite guide can be side spring loaded to keep the stack or screen protectors 14 square. The stack of screen protectors 14 can lift vertically in rise and fall by means of a screw driven by a motor. The top screen protector 14 can be at the correct position for the second pick-and-place mechanism 90 to grip it. A sensor can determine when a magazine 46 is empty.

In another aspect, the machine 10 can comprise one or more roles of protective film which can be custom cut or stamped. In another aspect, the machine 10 can contain a plurality of similar blanks that can be custom cut or stamped. Various aspects of cutting a screen protector from roles or blanks is shown and described in U.S. Pat. No. 10,416,621; and U.S. patent application Ser. No. 16/573,790 and 61/586,128, which are hereby incorporated herein by reference. Thus, the machine 10 can contain a plurality of screen protectors 14, such as 20 to 2000 screen protectors total or of each style. In another aspect, the machine can be an installation machine that can receive both the mobile device 22 and a preselected screen protector 14.

Referring to FIGS. 4-8 and 21-23, the delamination station 62 can comprise a delamination bed 170 to receive the screen protector 14 with the protective film 26 and to remove the protective film 26 from the screen protector 14 and expose the adhesive of the screen protector 14. The bed 170 can comprise a platen that is bifurcated with a channel therein. A gripper 174 can be movable on a screw drive 178 carried by the bed 170. The gripper 174 can grasp a tab 182 of the protective film 26 and peel the protective film 26 from the screen protector 14 as the gripper 174 moves through the channel in the platen.

Referring to FIGS. 4-8 and 24-29, the second pick-and-place mechanism 90 can have a vacuum grip 186 capable of gripping and retrieving the screen protector 14 with the protective film 26 from the magazine 46. In addition, the pick-and-place mechanism 90 can comprise horizontal and vertical screw drives to raise/lower and transport the grip 186 with the screen protector 14 with the protective film 26 from the magazine 46 to the delamination station 62 and the delamination bed 170; and to raise/lower and transport the grip 186 with the screen protector 14 without the protective film 26 from the delamination station 62 and the delamination bed 170 to the chuck 78 with the mobile device 22 in the lamination station 66.

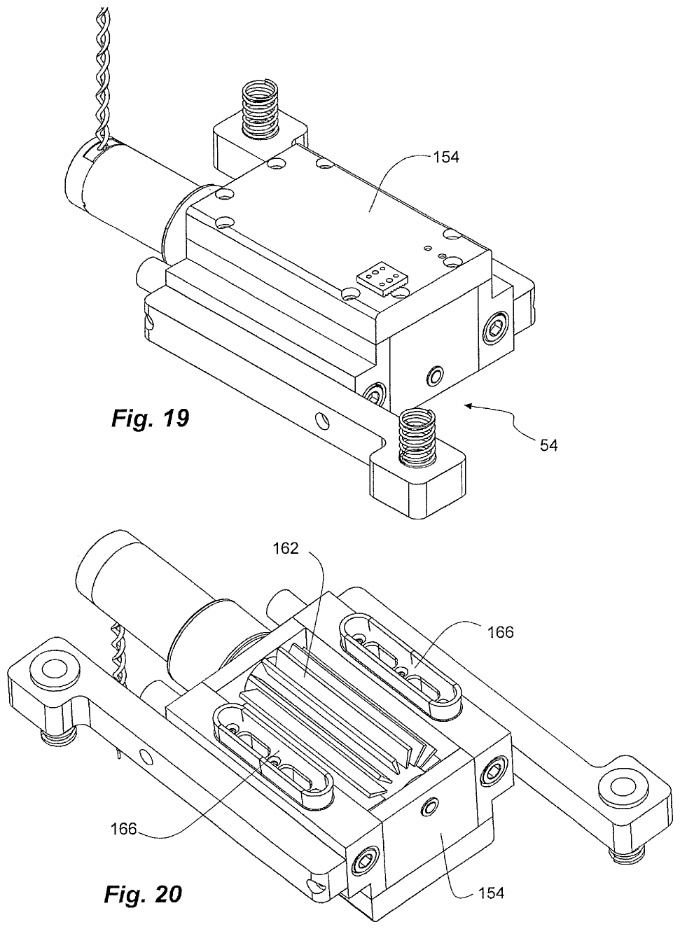

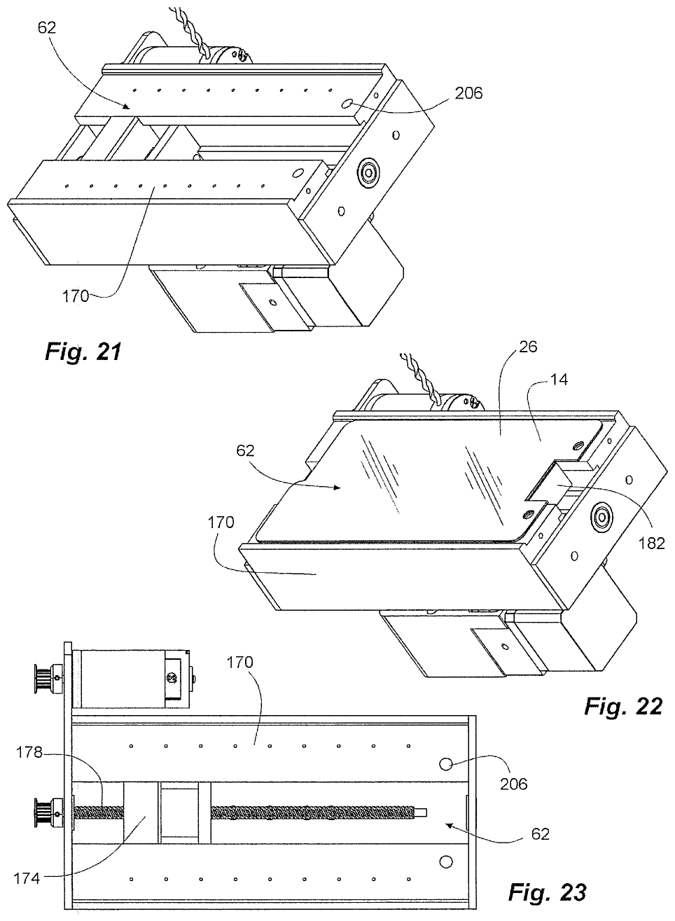

The vacuum grip 186 can have a platen 190 with a matrix of apertures 194 therein coupled to a vacuum source to hold the screen protector 14 against the platen 190 while the protective film 26 is peeled away from the screen protector 14. A heater or heating element 198 can be associated with the vacuum grip 186 to heat the platen 190, and thus to heat the adhesive on the screen protector 14. In one aspect, the vacuum grip 186 can have pins 202 extending therefrom and into bores 206 (FIGS. 21-23) in the platen of the delamination bed 170. The screen protector 14, or another outer protective film thereof, can have apertures corresponding to the pins 202. The pins 202 and bores 206 can index the vacuum grip 186 to the delamination bed 170.

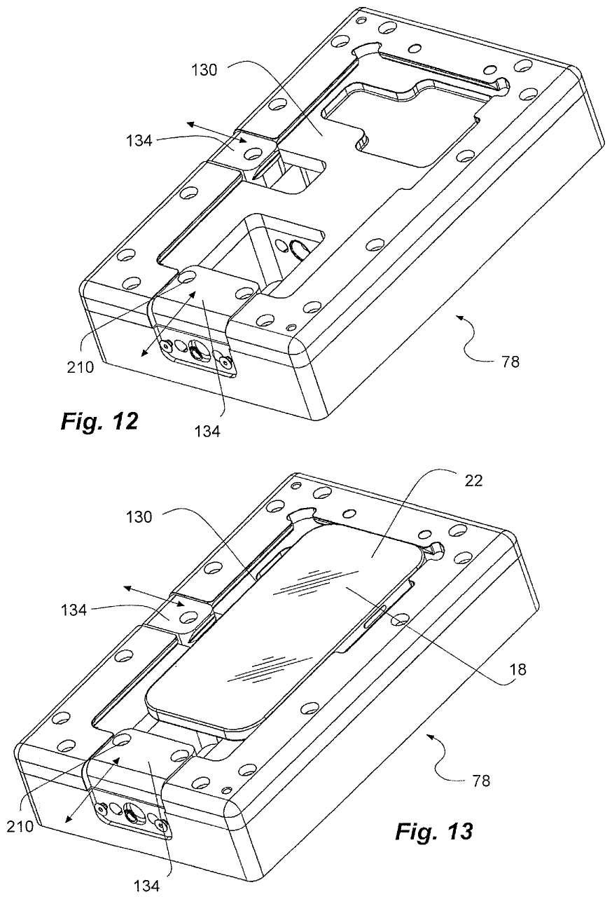

The second pick-and-place mechanism 90 can move the vacuum grip 186 to the magazine 46 where the vacuum grip 186 can grasp the screen protector 14. The second pick-and-place mechanism 90 can move the vacuum grip 186 with the screen protector 14 to the delamination station 62 and place the protective film 14 of the screen protector 14 on the platen of the delamination bed 170. The pins 202 of the vacuum grip 186 can index into the bores 206 of the delamination bed 170. The gripper 174 of the delamination bed 170 can grip the tab 182 of the protective film 26 and can peel the protective film 26 from the screen protector 14 as the vacuum grip 186 lifts the screen protector 14 from the delamination bed 14. The heater 198 can heat the platen 190 of the vacuum grip 186 and the adhesive of the screen protector 14. The second pick-and-place mechanism 90 can move the vacuum grip 186 with the screen protector 14 but without the protective film 26 from the delamination station 62 to the lamination station 66. The chuck 78 with the mobile device 22 is positioned in the lamination station 66 to receive the screen protector 14. The second pick-and-place mechanism 90 can place the vacuum grip 186 with the screen protector 14 against the screen 18 of the mobile device 22, thus pressing the adhesive of the screen protector 14 against the screen 18 of the mobile device 22. Thus, the vacuum grip 186 can be an applicator of the lamination station 62. In addition, the pins 202 can index into bores 210 (FIGS. 12-15) of the chuck 78 or the fingers thereof. Thus, the pins 202 and bores 210 can index the vacuum grip 186 to the chuck 78, and the screen protector 14 to the screen 18 of the mobile device 22. The vacuum grip 186 can then release the screen protector 14 and the second pick-and-place mechanism 90 can remove the vacuum grip 186 from the screen protector 14, the mobile device 22 and the chuck 78.

Referring to FIGS. 4-8 and 30, the sealing station 70 can have a vacuum chamber 214 to seal the screen protector 14 to the screen 18 of the mobile device 22, and to remove any air bubbles between the screen protector 14 and the screen 18. In one aspect, the chuck 78 can form a bottom portion of the vacuum chamber 214, and the sealing station 70 can have the other top portion 218 of the vacuum chamber 214 carried by actuators 222. The top portion 218 can have a gasket to seal against the bottom portion. When the chuck 78 with the mobile device 22 and the screen protector 14 enters the sealing station 70, the actuators 222 can close the other top portion 218 against the chuck 78 to form the vacuum chamber 214. The vacuum chamber 214 can be coupled to a vacuum source to reduce the pressure in the vacuum chamber 214 below ambient pressure, and mitigate entrained air bubbles from between the screen protector 14 and the screen 18. The vacuum chamber 214 can return pressure to ambient pressure and the actuators 222 can lift the other top portion 218 off of the chuck 78.

The chuck 78 with the mobile device 22 with the screen protector 14 thereon can be returned to the vision inspection station 54 to inspect the screen protector 14 and validate that the screen protector 14 was installed properly. In one aspect, the chuck 78 with the mobile device 22 with the screen protector 14 thereon can be returned to the cleaning station 58 to clean the screen protector 14.

Referring again to FIGS. 4-8, in another aspect, the machine 10, the mechanism 30, and the lamination station 66 can further comprise a roller station 226 with a roller 230 displaceable by actuators 234. The actuators 234 can bring the roller 230 into contact with the screen protector 14 and the chuck 78 can move under the roller 230, or back-and-forth under the roller 230, to press the screen protector 14 against the screen 18 of the mobile device 22.

The mechanism 30 and the stations with their components can be positioned on and carried by a platform. The rail 82 can extend through and/or beside the stations and their components.

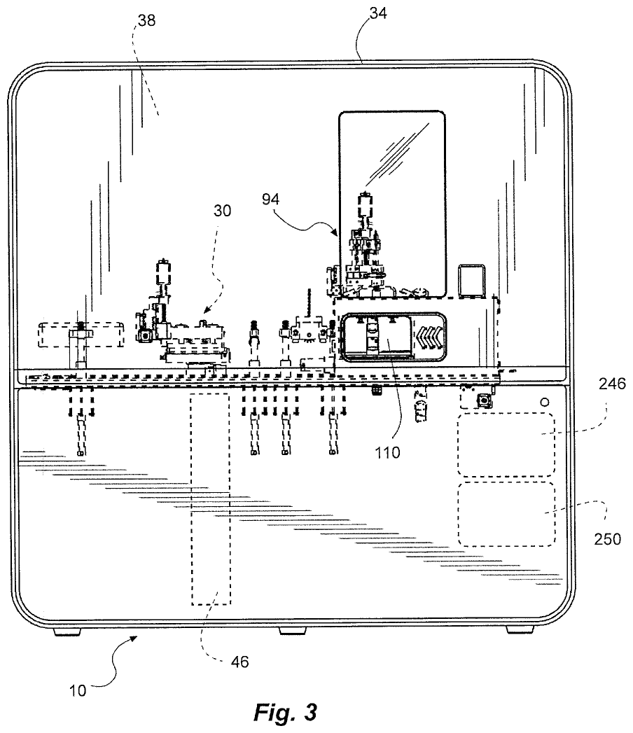

Referring again to FIGS. 2 and 3, the user input 94 can further comprise a controller 242 or control electronics, such as a computer, coupled to the display 98, the input 102, and the payment processor 106. Similarly, the mechanism 30 can further comprise a controller 246 or control electronics, such as a computer, coupled to and controlling the stations and their components. The controller 246 can have memory to record a condition and a verification of the mobile device 18 before and/or after installation of the screen protector 14. At least one vacuum source 250 can be located in the enclosure 34 to provide reduced pressure to grips and vacuum chambers of the stations. The machine 10 can also comprise a network interface for receiving one or more databases related to specific mobile devices in order to validate and install screen protectors properly, from a provider system, over an electronic communication network. This network interface will also be capable of transmitting information about stock levels and consumable material levels. This network interface can also be used to transmit new machine firmware, for the ability to update the machine for newly released mobile devices, or any user experience upgrades. Thus, the machine 10 can also be electronically connected via the network interface to a main control center and or database through a communication network. Thus, thus the machine 10 can send and receive data. In one aspect, operating instructions and information regarding screen protectors 14 and mobile devices 22 can be uploaded to the machine 10. The machine 10 can also have a controller 242 with one or more processors to receive input from the touch screen 98, and the network interface, the vision system, and the payment processing system 106; and to control the touch screen interface and the components of the machine, such as the door, the drawer, the lock, the storage system, the selection system, the alignment system, the vision system, the cleaning system, the installation system, the robotic arm and/or the conveyance, the platform, etc.

In one aspect, installation of the screen protector 14 on the mobile device 22 can occur within 30 minutes from the point the customer initiates the order. In another aspect, the machine 10 can also receive and store and transmit information including one or more of: date accessory or screen protector 14 was provided, time accessory or screen protector 14 was provided, location where the accessory or screen protector 14 was provided, identity of the party who requested the accessory via the touchscreen interface, validating information regarding the condition of the mobile device 22 and the screen protector 14.

In another aspect, the machine can also comprise a sterilizer, such as a UV light, to sterilize the mobile device.

In another aspect, the machine 10 and the user interface 94 can present and sell related accessories for the mobile device 22, including cases, power banks, cables, etc.

In another aspect, the machine 10 and the enclosure 34 can have a positive pressure system to maintain the interior 38 of the enclosure at an elevated pressure with respect to the ambient pressure outside of the enclosure to resist airborne particulates from entering the enclosure 34 and contaminating the mobile device 22 prior to installation of the screen protector 14. The positive pressure system can include a fan and a filter to draw filtered air into the enclosure.

As used in this specification and the appended claims, the singular forms “a,” “an” and “the” include plural referents unless the context clearly dictates otherwise. Thus, for example, reference to “a layer” includes a plurality of such layers.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open ended term in the specification, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility to a numerical range endpoint by providing that a given value may be “a little above” or “a little below” the endpoint. It is understood that express support is intended for exact numerical values in this specification, even when the term “about” is used in connection therewith.

The terms “interference fit” and “friction fit” and “press-fit” are terms of art used interchangeably herein to refer to deliberately causing, increasing and/or using friction to deliberately resist movement. An interference fit or friction fit is different than and great than the existence of friction. While friction may exist between any two surfaces, is often desirable to do all one can to reduce this friction. An interference fit or friction fit can be distinguished from naturally occurring friction by being actually deliberately caused and increased. An interference fit can be created by dimensioning engaging parts so that their surfaces tightly bear against one another. A friction fit can be created by surface roughness that is rougher.

The term “ferromagnetic” is used herein to refer to a material or element that has magnetic properties and/or an ability to magnetically couple, either by being magnetic, or being magnetically attracted to a magnet (such as by containing iron) such that one ferromagnetic material or element is magnetically attracted to another ferromagnetic material or element. Thus, a ferromagnetic button is a magnet or is magnetic, such as a permanent magnet, or is attracted to magnets, such as by containing iron.

It is to be understood that the examples set forth herein are not limited to the particular structures, process steps, or materials disclosed, but are extended to equivalents thereof as would be recognized by those ordinarily skilled in the relevant arts. It should also be understood that terminology employed herein is used for the purpose of describing particular examples only and is not intended to be limiting.

Furthermore, the described features, structures, or characteristics may be combined in any suitable manner in one or more examples. In the description, numerous specific details are provided, such as examples of lengths, widths, shapes, etc., to provide a thorough understanding of the technology being described. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the invention in one or more particular applications, it will be apparent to those of ordinary skill in the art that numerous modifications in form, usage and details of implementation can be made without the exercise of inventive faculty, and without departing from the principles and concepts described herein. Accordingly, it is not intended that the invention be limited, except as by the claims set forth below.

What is claimed is:

1. An autonomous application machine configured to install screen protectors on mobile devices, the machine comprising:
a) an enclosure with an interior;
b) a cleaning station in the interior of the enclosure and comprising a cleaning implement configured to contact a screen of the mobile device;
c) a magazine in the interior of the enclosure and configured to carry a plurality of screen protectors;
d) a lamination station in the interior of the enclosure and comprising an applicator to place a screen protector from the magazine on the screen of the mobile device; and
e) a vision inspection station in the interior of the enclosure and comprising a light source and a camera capable of:
i) initially visually inspecting the screen of mobile device prior to cleaning in the cleaning station and to verify that the screen is undamaged and free of an existing screen protector; and
ii) subsequently visually inspecting the screen protector on the mobile device after installation in the lamination station and to verify that the screen protector has been properly installed.

2. The machine in accordance with claim 1, further comprising:
a) a chuck in the interior of the enclosure configured to carry a mobile device during installation;
b) a receptacle associated with the enclosure and accessible only outside the enclosure, the receptacle configured to initially receive the mobile device and subsequently dispense the mobile device with the screen protector thereon; and
c) the receptacle being separate from the chuck.

3. The machine in accordance with claim 2, further comprising:
a first pick-and-place mechanism in the interior of the enclosure and comprising a vacuum grip capable of grasping the mobile device and transporting the mobile device from the receptacle to the chuck in the interior of the enclosure in a proper orientation.

4. The machine in accordance with claim 1, further comprising:
a user interface carried on an exterior of the enclosure and comprising a display and an input capable of presenting the screen protector for the mobile device and receiving a selection.

5. The machine in accordance with claim 1, further comprising:
a user interface carried on an exterior of the enclosure and comprising a display, an input, and a payment processor for presenting a screen protector for a mobile device and an installation service for installing the screen protector on the mobile device for sale, receiving a selection and processes a payment for the screen protector and the installation service.

6. The machine in accordance with claim 1, wherein the lamination station and the applicator further comprises:
a) a pick-and-place mechanism with a vacuum grip capable of gripping and retrieving the screen protector with a protective film from the magazine;
b) a delamination bed to receive the screen protector with the protective film and remove the protective film; and
c) a heater associated with the vacuum grip of the pick-and-place mechanism to heat an adhesive on the screen protector.

7. The machine in accordance with claim 1, further comprising:
a sealing station with a vacuum chamber to seal the screen protector to the screen of the mobile device.

8. An autonomous application machine configured to install screen protectors on mobile devices, the machine comprising:
a) an enclosure with an interior;
b) a chuck in the interior of the enclosure configured to carry a mobile device during installation;
c) a receptacle associated with the enclosure and accessible only outside the enclosure, the receptacle configured to initially receive the mobile device and subsequently dispense the mobile device with the screen protector thereon; and
d) the receptacle being separate from the chuck.

9. The machine in accordance with claim 8, further comprising:
a pick-and-place mechanism in the interior of the enclosure and comprising a vacuum grip capable of grasping the mobile device and transporting the mobile device from the receptacle to the chuck in the interior of the enclosure in a proper orientation.

10. The machine in accordance with claim 8, further comprising:
a vision inspection station in the interior of the enclosure and comprising a light source and a camera capable of:
i) initially visually inspecting the screen of mobile device prior installation of the screen protector and to verify that the screen is undamaged and free of an existing screen protector, and
ii) subsequently visually inspecting the screen protector on the mobile device after installation and to verify that the screen protector has been properly installed.

11. The machine in accordance with claim 8, further comprising:
a user interface carried on an exterior of the enclosure and comprising a display and an input capable of presenting the screen protector for the mobile device and receiving a selection.

12. The machine in accordance with claim 8, further comprising:
a user interface carried on an exterior of the enclosure and comprising a display, an input, and a payment processor for presenting a screen protector for a mobile device and an installation service for installing the screen protector on the mobile device for sale, receiving a selection and processes a payment for the screen protector and the installation service.

13. The machine in accordance with claim 8, further comprising:
a) a cleaning station in the interior of the enclosure and comprising a cleaning implement configured to contact a screen of the mobile device;
b) a magazine in the interior of the enclosure and configured to carry a plurality of screen protectors;
c) a lamination station in the interior of the enclosure and comprising an applicator to place a screen protector from the magazine on the screen of the mobile device;
d) a pick-and-place mechanism with a vacuum grip capable of gripping and retrieving the screen protector with a protective film from the magazine;
e) a delamination bed to receive the screen protector with the protective film and remove the protective film; and
f) a heater associated with the vacuum grip of the pick-and-place mechanism to heat an adhesive on the screen protector.

14. The machine in accordance with claim 8, further comprising:
a sealing station with a vacuum chamber to seal the screen protector to the screen of the mobile device.

15. An autonomous application machine configured to install screen protectors on mobile devices, the machine comprising:
a) an enclosure with an interior;
b) a user interface carried on an exterior of the enclosure and comprising a display, an input, and a payment processor for presenting a screen protector for a mobile device and an installation service for installing the screen protector on the mobile device for sale, receiving a selection and processes a payment for the screen protector and the installation service;
c) a cleaning station in the interior of the enclosure and comprising a cleaning implement configured to contact a screen of the mobile device;
d) a magazine in the interior of the enclosure and configured to carry a plurality of screen protectors; and
e) an lamination station in the interior of the enclosure and comprising an applicator to place a screen protector from the magazine on the screen of the mobile device.

16. The machine in accordance with claim 15, further comprising:
a vision inspection station in the interior of the enclosure and comprising a light source and a camera capable of:
i) initially visually inspecting the screen of mobile device prior installation of the screen protector and to verify that the screen is undamaged and free of an existing screen protector; and
ii) subsequently visually inspecting the screen protector on the mobile device after installation and to verify that the screen protector has been properly installed.

17. The machine in accordance with claim 15, further comprising:
a) a chuck in the interior of the enclosure and configured to carry a mobile device during installation;
b) a receptacle associated with the enclosure and accessible only outside the enclosure, the receptacle configured to initially receive the mobile device and subsequently dispense the mobile device with the screen protector thereon; and
c) the receptacle being separate from the chuck.

18. The machine in accordance with claim 15, further comprising:
a pick-and-place mechanism in the interior of the enclosure and comprising a vacuum grip capable of grasping the mobile device and transporting the mobile device from the receptacle to the chuck in the interior of the enclosure in a proper orientation.

19. The machine in accordance with claim 15, wherein the lamination station and the applicator further comprises:
a) a pick-and-place mechanism with a vacuum grip capable of gripping and retrieving the screen protector with a protective film from the magazine;
b) a delamination bed to receive the screen protector with the protective film and remove the protective film; and
c) a heater associated with the vacuum grip of the pick-and-place mechanism to heat an adhesive on the screen protector.

20. The machine in accordance with claim 15, further comprising:
a sealing station with a vacuum chamber to seal the screen protector to the screen of the mobile device.
